(19) United States
(12) Patent Application Publication
(10) Pub. No.: US 2026/0359383 A1
(43) Pub. Date: Nov. 12, 2026

(54) LOCALIZED WAVE-LEVEL OUTPUT STORAGE

(71) Applicant: QUALCOMM Incorporated, San Diego, CA (US)

(72) Inventors: Elina KAMENETSKAYA, Belmont, MA (US); Amir MOMENI, Arlington, MA (US); Fei WEI, San Diego, CA (US); Leiming YU, Lynnfield, MA (US)

(21) Appl. No.: 19/202,758

(22) Filed: May 8, 2025

(51) Int. Cl. G06F 17/16

(52) U.S. Cl. CPC G06F 17/16

(57) ABSTRACT

Aspects presented herein relate to methods and devices for graphics processing including an apparatus, e.g., a GPU. The apparatus may allocate a portion of a storage unit for a first wave of first data, where the first data represents a block of output data. The apparatus may also store the first wave of the first data as an initial accumulator value for a matrix multiplication accumulation process. Further, the apparatus may process the first data and second data included in the first wave, wherein the second data represents a block of input data.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may execute a number of different instructions in a graphics processing pipeline. However, there has developed a need for improved instruction execution in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain a first wave of first data associated with graphics processing, where an allocation of a portion of a storage unit is based on the obtainment. The apparatus may also allocate a portion of a storage unit for a first wave of first data, where the first data represents a block of output data. The apparatus may also store the first wave of the first data as an initial accumulator value for a matrix multiplication accumulation process. Additionally, the apparatus may process the first data and second data included in the first wave, where the second data represents a block of input data. The apparatus may also update the initial accumulator value of the first data to be an updated accumulator value of the first data based on a result of the processing of the first data and the second data. The apparatus may also provide an indication of the updated accumulator value of the first data to at least one other component in a graphics processing unit (GPU). Moreover, the apparatus may allocate a second portion of the storage unit for a second wave of third data. The apparatus may also store the second wave of the third data as a second initial accumulator value for the matrix multiplication accumulation process. The apparatus may also process the third data and fourth data included in the second wave. The apparatus may also update the second initial accumulator value of the third data based on a result of the processing of the third data and the fourth data. The apparatus may also store the updated accumulator value of the first data to a general purpose register (GPR). The apparatus may also deallocate the portion of the storage unit for the first wave of the first data based on the storage of the updated accumulator value of the first data. The apparatus may also output an indication of a result of the processing of the first data and the second data.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 includes diagrams illustrating an example GPU in accordance with one or more techniques of this disclosure.

FIG. 8 is a diagram illustrating an example matrix multiplication process in accordance with one or more techniques of this disclosure.

FIG. 9 is a diagram illustrating an example matrix multiplication process in accordance with one or more techniques of this disclosure.

FIG. 10 is a diagram illustrating an example storage process in accordance with one or more techniques of this disclosure.

FIG. 11 is a diagram illustrating an example storage process in accordance with one or more techniques of this disclosure.

FIG. 12 is a diagram illustrating an example wave level storage process in accordance with one or more techniques of this disclosure.

FIG. 13 is a diagram illustrating an example wave level storage process in accordance with one or more techniques of this disclosure.

FIG. 14 is a communication flow diagram illustrating example communications between a GPU, a CPU/GPU, and a memory in accordance with one or more techniques of this disclosure.

FIG. 15 is a flowchart of an example method of graphics processing in accordance with one or more techniques of this disclosure.

FIG. 16 is a flowchart of an example method of graphics processing in accordance with one or more techniques of this disclosure.

### DETAILED DESCRIPTION

GPU shader processors (SPs) may include dedicated matrix multiplication hardware accelerators. These dedicated matrix multiplication hardware accelerators may operate on wave-level input matrices A and B stored in a general purpose register (GPR) or local memory at the GPU, in order to produce an output result matrix C. This process is generally completed using wave-level tiles of the input matrices, with the accumulation into the C matrix continuing until the entire (multi-tile) accumulation is complete. Many matrix multiplication engines may rely on an outer-product based flow, where a column of matrix A is cross multiplied by a row of matrix B, thus resulting in a partial result of matrix C the size of the computed outer product. This approach of an outer-product based flow may benefit from zero re-read of the input data for matrix A and matrix B. However, the outer product approach may need large storage and high read/write throughput for matrix C. Therefore, it may be impractical for large outer product shapes. On the other end of the spectrum is the inner product, which may cause severe re-read of input data for matrix A and matrix B. However, the inner product approach may need minimal storage and read/write throughput for the output matrix C. GPUs that utilize efficient hardware may strive to achieve a balance point between the outer product approach and the inner product approach. The existing industry storage and read/write bandwidth choice for output matrix C is in the GPR. That is, most of this storage utilization from the result of this matrix multiplication is from the output matrix C. And the issue is that by storing all of the matrix C output in GPR, then the GPR gets backlogged. So the problem is that the storage and use of the read write bandwidth for the output matrix C for matrix multiplication is in the GPR. And the sole way to mitigate GPR read and write bandwidth penalty is to increase the accumulation steps in the K dimension (where K is the number of computations that are needed for each M and N combination). However, by doing so, performance and power at the GPU is expected to degrade as the tile step-size in the K dimension increases. Based on the above, it may be beneficial to optimize or improve a GPU's ability to handle data storage for certain operations. That is, it may be beneficial to allow a GPU to optimize a storage capability for matrix multiplication. Aspects herein may optimize or improve a GPU's ability to handle data storage for certain operations.

Aspects of the present disclosure may include a number of benefits or advantages. For instance, aspects of the present disclosure may optimize or improve a GPU's ability to handle data storage for certain operations. Aspects presented herein may allow a GPU to optimize a storage capability for matrix multiplication. That is, aspects presented herein may utilize a separate storage unit at a GPU for matrix multiplication. Indeed, aspects presented herein may utilize a per-wave storage space that is adjacent to the matrix multiplication engines at the GPU. For example, aspects herein may utilize localized wave-level output storage for GPU-based matrix multiplication. Also, aspects herein may move certain storage closer to the matrix multiplication engines in the GPU. Aspects presented herein may also utilize the GPR for other storage issues in parallel with the matrix multiplication process. In turn, this may allow a GPU to reduce the amount of power consumption at the GPR. By doing so, aspects presented herein may allow a GPU to optimize power consumption and storage capability. In turn, this may optimize or improve the overall performance of a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

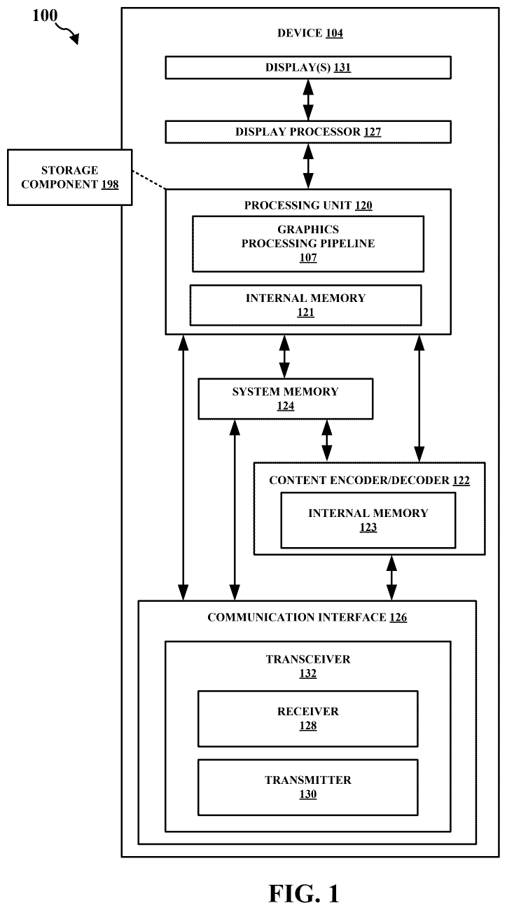

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a storage component 198 configured to obtain a first wave of first data associated with graphics processing, where an allocation of a portion of a storage unit is based on the obtainment. The storage component 198 may also be configured to allocate a portion of a storage unit for a first wave of first data, where the first data represents a block of output data. The storage component 198 may also be configured to store the first wave of the first data as an initial accumulator value for a matrix multiplication accumulation process. The storage component 198 may also be configured to process the first data and second data included in the first wave, where the second data represents a block of input data. The storage component 198 may also be configured to update the initial accumulator value of the first data to be an updated accumulator value of the first data based on a result of the processing of the first data and the second data. The storage component 198 may also be configured to provide an indication of the updated accumulator value of the first data to at least one other component in a graphics processing unit (GPU). The storage component 198 may also be configured to allocate a second portion of the storage unit for a second wave of third data. The storage component 198 may also be configured to store the second wave of the third data as a second initial accumulator value for the matrix multiplication accumulation process. The storage component 198 may also be configured to process the third data and fourth data included in the second wave. The storage component 198 may also be configured to update the second initial accumulator value of the third data based on a result of the processing of the third data and the fourth data. The storage component 198 may also be configured to store the updated accumulator value of the first data to a general purpose register (GPR). The storage component 198 may also be configured to deallocate the portion of the storage unit for the first wave of the first data based on the storage of the updated accumulator value of the first data. The storage component 198 may also be configured to output an indication of a result of the processing of the first data and the second data. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

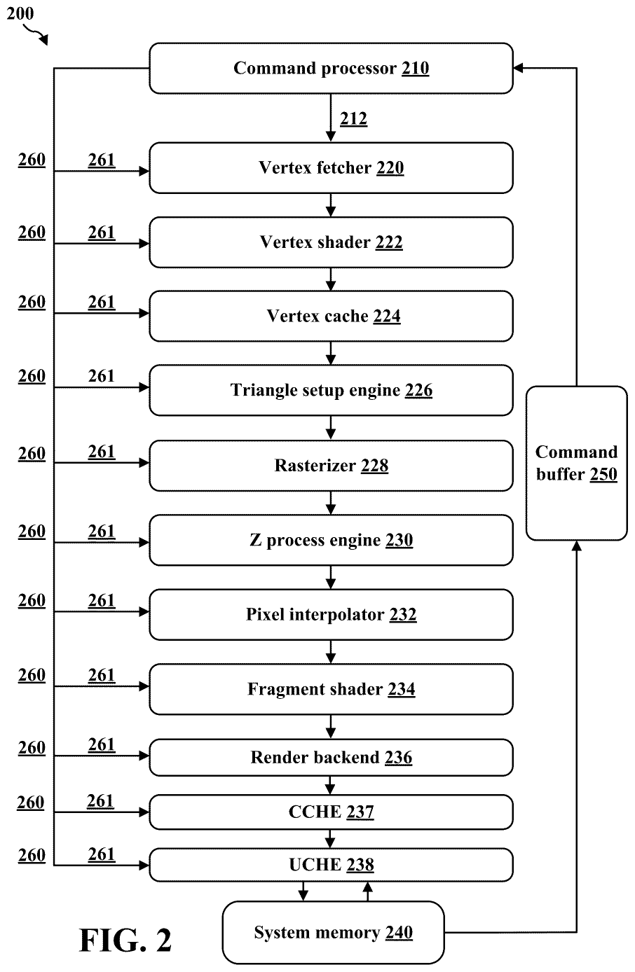

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

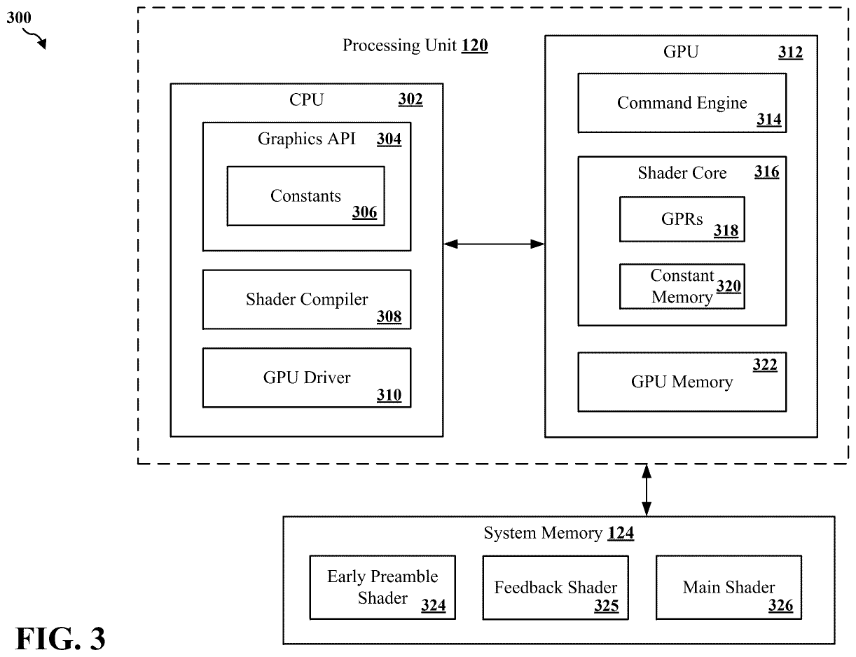

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

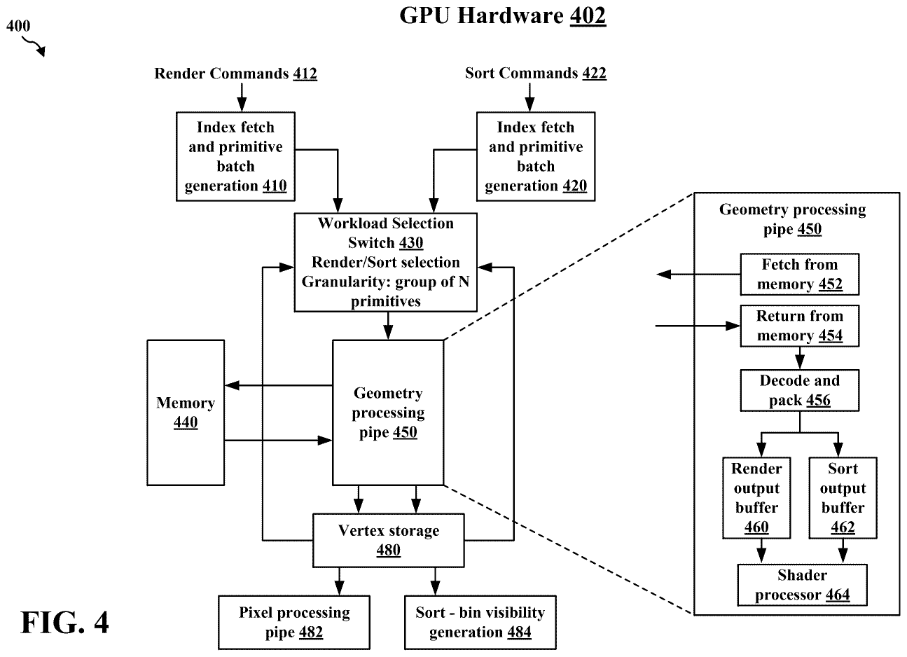

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 480, pixel processing pipe 482, and sort-bin visibility generation component 484. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 480, which may be sent to pixel processing pipe 482 and sort-bin visibility generation component 484.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

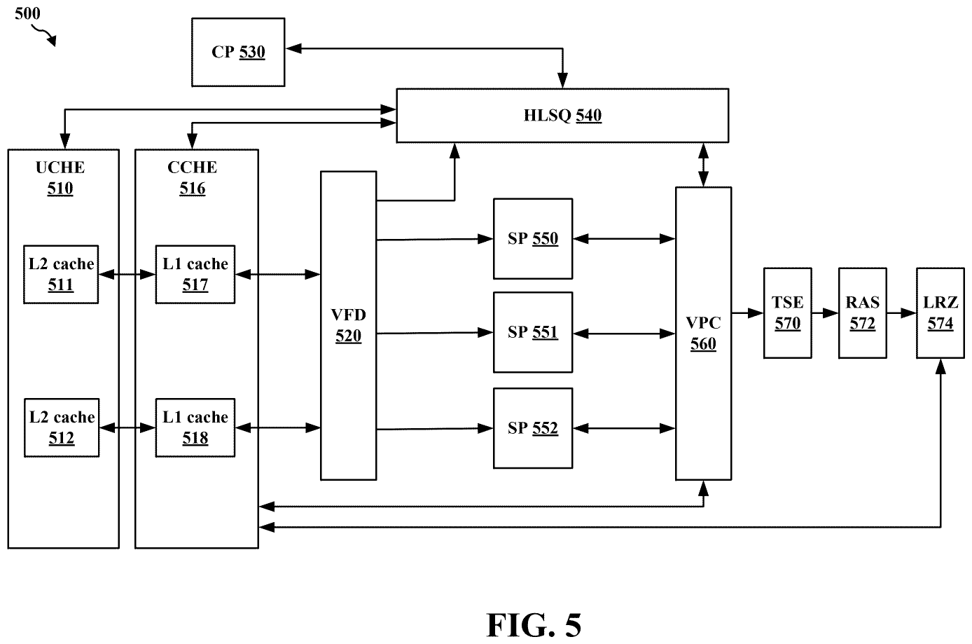

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of shader processors (e.g., shader processor 550, shader processor 551, and shader processor 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to shader processors 550-552. Moreover, shader processors 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

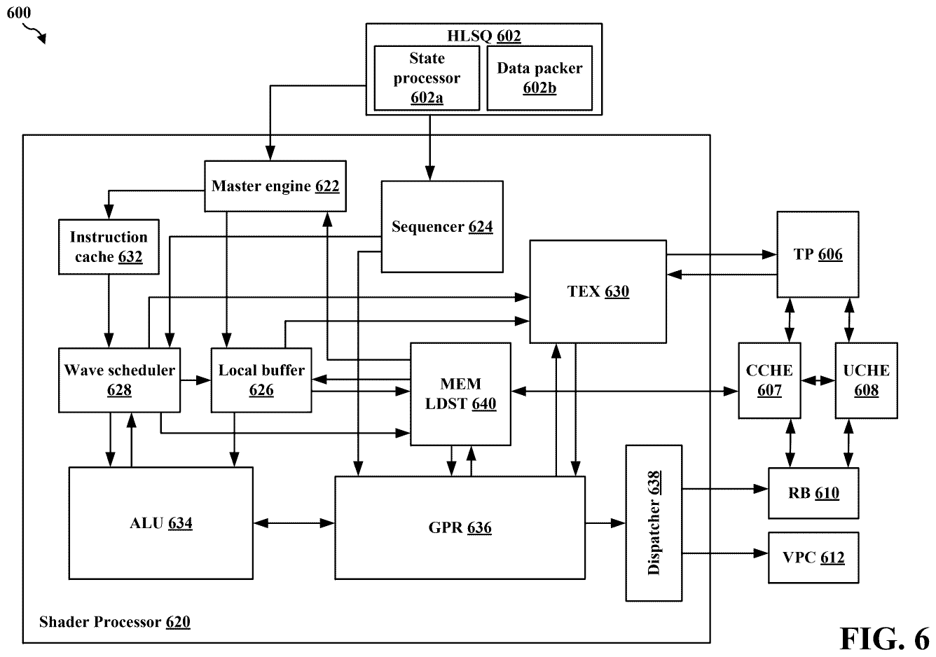

FIG. 6 illustrates an example GPU 600. Specifically, FIG. 6 illustrates shader processor system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes shader processor (SP) 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640. In some aspects, shader processor (SP) 620 may be referred to as a shader processor.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

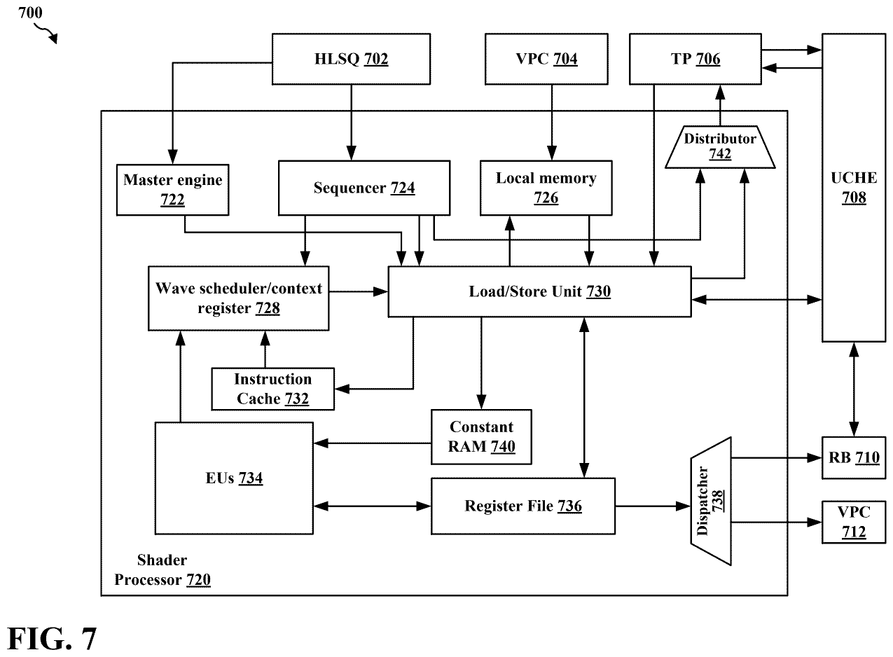

FIG. 7 illustrates an example GPU 700. More specifically, FIG. 7 illustrates a shader processor (SP) system in GPU 700. As shown in FIG. 7, GPU 700 includes high level sequencer (HLSQ) 702, VPC 704, texture processor (TP) 706, UCHE 708 (e.g., an L2 configurable cache), RB 710, VPC 712, and SP 720. SP 720 includes master engine 722, sequencer 724, local memory 726, wave scheduler/context register 728, load/store unit 730 (e.g., texture (TEX) or load controller), instruction cache 732, execution units (EUs) 734, register file 736 (e.g., a general purpose register (GPR)), dispatcher 738 (e.g., texture distributor), constant RAM 740, and output distributor 742. The wave scheduler/context register 728 may include one or more wave slots. In some aspects, shader processor (SP) 720 may be referred to as a streaming processor.

As shown in FIG. 7, the SP 720 may include traditional function units or blocks (e.g., EUs 734 or sequencer 724). EUs 734 may execute or process some of the desired functions of the GPU. The sequencer 724 may allocate resources and local memory. Also, the sequencer 724 may allocate wave slots and any associated register file 736 space. For example, the sequencer 724 may allocate wave slots or register file 736 space when the HLSQ 702 issues a pixel tile workload to the SP 720. In some aspects, the wave scheduler/context register 728 may execute a pixel shader or issue instructions to the EUs 734. The EUs 734 may also include an arithmetic logic unit (ALU) and/or an elementary function unit (EFU). Further, the load/store unit 730 may be considered an execution unit. Moreover, the load/store unit 730 may correspond to one or multiple units. For instance, the load/store unit 730 may perform a texture fetch and/or the load/store unit 730 may perform a memory fetch. In some aspects, the instruction cache 732 may store a program to be executed. Also, the constant RAM 740 may store the constant that may be needed for a constant or uniform formation. As further shown in FIG. 7, the SP 720 may interface with the outside blocks, e.g., HLSQ 702, VPC 704, TP 706, UCHE 708, RB 710, and VPC 712. These blocks 702-712 may utilize user provided input and/or the SP may output results to these blocks or memory access.

As shown in FIG. 7, each unit or block in GPU 700 may send data or information to other blocks. For instance, HLSQ 702 may send programming/commands to the master engine 722. Also, HLSQ 702 may send vertex threads, vertex attributes, pixel threads, and/or pixel attributes to the sequencer 724. Master engine 722 may send an instruction, constant request to load/store unit 730. VPC 704 may send certain coefficients to local memory 726. TP 706 may send texture data to the load/store unit 730. TP 706 may also receive texture requests from load/store unit 730, e.g., via output distributor 742, and bypass requests from sequencer 724. Further, TP 706 may send requests to and receive texture elements (texels) from UCHE 708. UCHE 708 may also send memory data to and receive memory requests from load/store unit 730, as well as send memory data to and receive memory requests from RB 710. Also, RB 710 may receive an output in the form of color from register file, e.g., via dispatcher 738. VPC 712 may also receive output in the form of vertices from register file 736, e.g., via dispatcher 738. Register file 736 may also send temporary data to and receive temporary data from EUs 734. Moreover, EUs 734 may send address or predicate information to the wave scheduler/context register 728, as well as receive constant data from constant RAM 740. Load/store unit 730 may also send/receive load or store data to/from register file 736, as well as send store data to, and receive load data from, local memory 726. Further, load/store unit 730 may send global data to constant RAM 740 and update information to the instruction cache 732. Load/store unit 730 may also receive attribute data from sequencer 724 and synchronization information from wave scheduler/context register 728. Additionally, wave scheduler/context register 728 may receive decode information from instruction cache 732 and thread data from sequencer 724.

As mentioned above, the GPU 700 may process workloads (e.g., a pixel or vertex workload). In some aspects, these workloads may correspond to, or be referred to as, waves or wave formations. For instance, each workload or operation may use a group of vertices or pixels as a wave. For example, each wave may include 64 vertices or 64 pixels. In some instances, GPU 700 may send a wave formation, e.g., a pixel or vertex workload, to the wave scheduler/context register 728 for execution. For a vertex workload, the GPU may perform a vertex transformation. For a pixel workload, the GPU may perform a pixel shading or lighting.

In some aspects, each of the aforementioned processes or workloads (e.g., the processes or workloads in the SP 720) may include a wave formation. For example, a vertex workload may include a number of vertices, e.g., three vertices. SP 720 may then perform a transformation of these vertices, such that the vertices may transform into a wave. In order to perform this transformation, GPUs may utilize a number of a wave slots (e.g., to help transform the vertices into a wave). Further, in order to execute a workload or program, the GPU may also allocate the GPR space, e.g., including a temporary register to store any temporary data. Additionally, the sequencer 724 may allocate the register file 736 space and one or more wave slots in order to execute a wave. For example, the register file 736 space and one or more wave slots may be allocated when a pixel or vertex workload is issued. In some aspects, the wave scheduler/context register 728 may process a pixel workload and/or issue instructions to various execution units (e.g., EUs 734). The wave scheduler/context register 728 may also help to ensure data dependency between instructions, e.g., data dependency between ALU operands due to the pipeline latency and/or texture sample return data dependency based on a synchronization mechanism.

As shown in FIG. 7 above, GPUs may utilize a shader processor (SP) 720 (e.g., a sequencer 724 in SP 720) to allocate different workloads to different wave slots. For instance, sequencer 724 may allocate wave slots and associated general purpose register (GPR) space for workloads (e.g., a high level sequencer (HLSQ) issue pixel tile workload (i/j barycentric coefficient data)) to SP 720. Next, a wave scheduler/context register 728 may execute a pixel shader and issue instructions to execution units (EUs) 734 (e.g., arithmetic logic unit (ALU), elementary function unit (EFU), texture (TEX) or load controller (LOAD)). After the shader processing is complete, the SP 720 may dispatch the processed result (i.e., mostly color) to a downstream block (e.g., a render backend (RB) 710). In some aspects, the output order of this process may be the same as the input order, which may be a functional specification. The SP 720 may work efficiently because wave slots that accept and execute a workload earlier may generally finish processing the workload earlier.

In some aspects, as shown in FIG. 7, high level sequencer (HLSQ) 702 may dispatch context states such as global register, shader constant, buffer descriptor, instruction, etc. The HLSQ 702 may also embed context states into a command stream to the master engine 722 (e.g., an SP master engine). In turn, the master engine 722 (e.g., an SP master engine) may parse the command stream from HLSQ 702 and set up an SP global state. The sequencer 724 (aka SEQ) may then allocate wave slots and associated GPR space when the HLSQ 702 dispatches workloads (e.g., vertex or pixel tile workloads) to the SP. Then the wave scheduler/context register 728 may execute vertex or pixel shader workloads and issue instructions to execution units (EUs) 734, such as ALU, EFU, TEX/LOAD, etc. After the shader processing is complete, the SP 720 may dispatch the result to a downstream block (e.g., render backend (RB) 710).

In some aspects, as described herein, a graphics processing unit (GPU) may represent one or more dedicated processors for performing graphical operations. A GPU may be a dedicated hardware unit having fixed function and programmable components for rendering graphics and executing GPU applications. In some cases, a GPU may implement a parallel processing structure that may provide for more efficient processing of complex graphic-related operations. For example, a GPU may include a plurality of processing elements that are configured to operate in a parallel manner, which may allow the GPU to generate graphic images for display (e.g., for graphical user interfaces, for display of two-dimensional or three-dimensional graphics scenes, etc.).

In some cases, a GPU may execute a shader (e.g., a shader program, a graphics program, a computer program, etc.) to perform various specialized functions in various fields of computer graphics. For example, shaders may be used widely in post-processing, computer-generated imagery, multimedia display, video games, etc. (e.g., to produce a wide range of effects such as production of appropriate levels of light, darkness, and color within an image, such as alteration of hue, saturation, brightness or contrast of an image, such as production of blur, light bloom, volumetric lighting, normal mapping for depth effects, distortion, such as edge detection, motion detection, etc.). A GPU may thus execute a shader to transform two-dimensional or three-dimensional data into useful two-dimensional data for displaying.

Shaders may be written to apply transformations to a large set of elements at a time (e.g., to each pixel in an area of a screen, or for every vertex of a model). GPUs may execute shaders via parallel processing, and a GPU may have multiple shader pipelines (e.g., threads) to facilitate such parallel processing and improve computation throughput. Efficient compute operations may often rely on getting waves synchronized in a desired pattern. GPUs may implement systems of wave scheduling, however in some cases such scheduling may interfere with or contradict best execution for some types of workloads. In some cases, GPUs may handle non-uniform and irregular workloads for graphics, and current lock/barrier mechanisms may be deficient in achieving ideal synchronization patterns (e.g., lock/barrier mechanisms may force a wave to wait for others to catch up, which may result in processing delays). For example, in some cases, a shader structure may include loops (e.g., loop0, loop1, loop2, etc.). These loops may be for different waves (e.g., wave0, wave1, wave2, etc.). Subsequent loops (e.g., loop1 for wave0) may interrupt arithmetic logic unit (ALU) processing being performed for an earlier loop (e.g., loop0 of wave2), which may result in processing interruptions (for loop0 of wave2).

Additionally, GPU SPs may execute programs (kernels) written from the perspective of individual fibers, where each fiber executes a sequence of instructions independently from other fibers. This results in inefficiencies for use cases where data sharing is important and cross-fiber synchronization is needed to execute a program efficiently. Synchronization of fibers within a wave typically may occur naturally because of vectorized compute and other units used in SPs. However, synchronization beyond a single wave is typically costly for the GPU. Existing methods for synchronizing across waves include barriers (which allow synchronization within a workgroup) and atomics (which can synchronize beyond a single workgroup). Both approaches may force some waves to wait while others catch up, resulting in performance inefficiencies due to stalls in the workload execution.

In mathematics and graphics processing, matrix multiplication is a binary operation that produces a matrix from two or more matrices. For the process of matrix multiplication, the number of columns in one matrix (e.g., the first matrix) may need to be equal to the number of rows in another matrix (e.g., the second matrix). For instance, to multiply one matrix by another matrix, the process may need to perform the dot product of rows and columns. The resulting matrix, known as the matrix product, may have the number of rows of one matrix (e.g., the first matrix) and the number of columns of another matrix (e.g., the second matrix). In one example, the product of matrix A and matrix B may be denoted as matrix AB. Also, in one instance, the product of matrix A and matrix B may be denoted as matrix C.

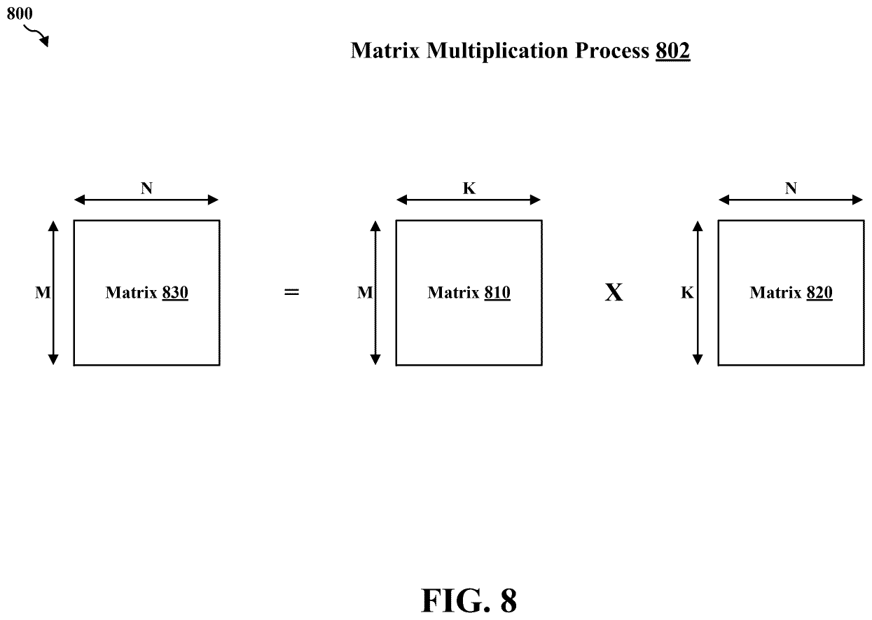

FIG. 8 illustrates diagrams including one example of a matrix multiplication process. More specifically, diagram 800 depicts an example matrix multiplication process 802 at a GPU. Diagram 800 includes matrix 810 (e.g., matrix A), matrix 820 (e.g., matrix B), and matrix 830 (e.g., matrix C). As shown in FIG. 8, matrix 810 includes M rows and K columns, matrix 820 includes K rows and N columns, and matrix 830 includes M rows and N columns. As depicted in FIG. 8, matrix 810 (e.g., matrix A) is multiplied with matrix 820 (e.g., matrix B) in order to produce matrix 830 (e.g., matrix C). Thus, the standard matrix multiplication formula is matrix A x matrix B=matrix C. FIG. 8 depicts matrix multiplication on a GPU using wave-level input tiles from matrix 810 (e.g., matrix A) and matrix 820 (e.g., matrix B). The accumulation continues for multiple steps, or tiles, into the accumulator result matrix 830 (e.g., matrix C) until all tiles contributing to this section of the C output have been traversed.

GPU shader processors (SPs) may include dedicated matrix multiplication hardware accelerators. These dedicated matrix multiplication hardware accelerators may operate on wave-level input matrices A and B stored in a general purpose register (GPR) or local memory at the GPU, in order to produce an output result matrix C. This process is generally completed using wave-level tiles of the input matrices, with the accumulation into the C matrix continuing until the entire (multi-tile) accumulation is complete. Many matrix multiplication engines may rely on an outer-product based flow, where a column of matrix A is cross multiplied by a row of matrix B, thus resulting in a partial result of matrix C the size of the computed outer product. This approach of an outer-product based flow may benefit from zero re-read of the input data for matrix A and matrix B. However, the outer product approach may need large storage and high read/write throughput for matrix C. Therefore, it may be impractical for large outer product shapes. On the other end of the spectrum is the inner product, which may cause severe re-read of input data for matrix A and matrix B. However, the inner product approach may need minimal storage and read/write throughput for the output matrix C. GPUs that utilize efficient hardware may strive to achieve a balance point between the outer product approach and the inner product approach.

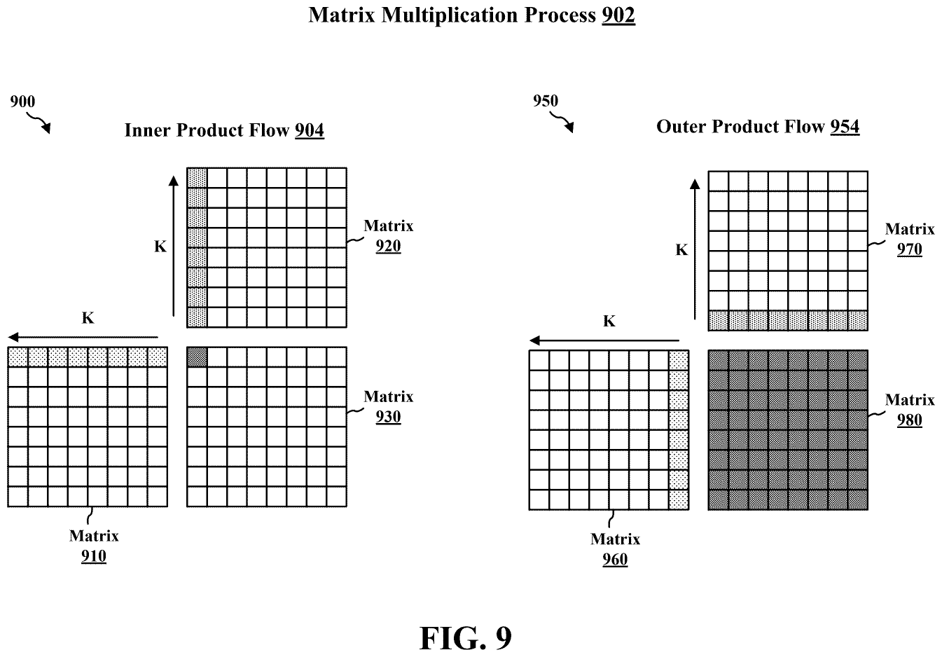

FIG. 9 illustrates diagrams including one example of a matrix multiplication process. More specifically, diagram 900 and diagram 950 depict an example matrix multiplication process 902 at a GPU. Diagram 900 depicts inner product flow 904 including matrix 910, matrix 920, and matrix 930. As shown in diagram 900, matrix 910 includes K columns and matrix 920 includes K rows. The inner product flow 904 multiplies one row in matrix 910 by one column in matrix 920, which results in one output result at matrix 930. Accordingly, multiplying one row by one column is a lot of work for one output, which may not utilize a large amount of space. The tradeoff of the inner product flow 904 is a small amount of storage at matrix 930 (e.g., matrix C) compared to a large amount of re-reads of matrix 910 (e.g., matrix A) and matrix 920 (e.g., matrix B). In contrast, diagram 950 depicts outer product flow 954 including matrix 960, matrix 960, and matrix 980. As shown in diagram 950, matrix 960 includes K columns and matrix 970 includes K rows. The outer product flow 954 multiplies one column in matrix 960 by one row in matrix 970, which results in many output results at matrix 980. As such, multiplying one column by one row is a small amount of work for many outputs, which may utilize a large amount of space and result in a partial final result. The tradeoff of the outer product flow 954 is a large amount of storage at matrix 980 (e.g., matrix C) compared to a small amount of re-reads (e.g., 0 re-reads) of matrix 960 (e.g., matrix A) and matrix 970 (e.g., matrix B).

As shown in FIG. 9, there is a tradeoff for matrix multiplication between outer product flow 954 and inner product flow 904. The inner product flow 904 results in multiple re-reads of input data while reducing pressure on matrix 930 storage, as well as read/write bandwidth. For example, there may be a large amount of re-reads of matrix 910 (e.g., matrix A) and matrix 920 (e.g., matrix B) compared to a small amount of storage at matrix 930 (e.g., matrix C). The outer product flow 954 may provide a single input data read, however, it is not practical for large tiles since the storage at matrix 980 (e.g., matrix C) and read/write bandwidth utilization may grow quadratically as the M×N tile size increases. That is, the outer product flow 954 may result in a large amount of storage at matrix 980 (e.g., matrix C) compared to a small amount of re-reads of matrix 960 (e.g., matrix A) and matrix 970 (e.g., matrix B).

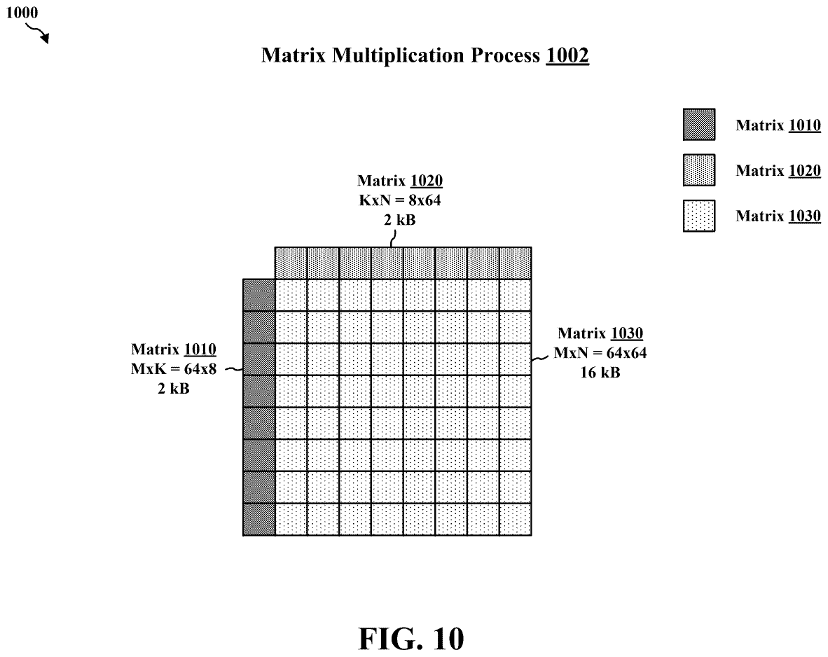

FIG. 10 illustrates diagrams including one example of a matrix multiplication process. More specifically, diagram 1000 depicts an example matrix multiplication process 1002 at a GPU. Diagram 1000 includes matrix 1010, matrix 1020, and matrix 1030. As shown in FIG. 10, matrix 1010 includes M rows and K columns (e.g., 64 rows and 8 columns), matrix 1020 includes K rows and M columns (e.g., 8 rows and 64 columns), and matrix 1030 includes M rows and N columns (e.g., 64 rows and 64 columns). As depicted in FIG. 10, matrix 1010 corresponds to 2 kB, matrix 1020 corresponds to 2 kB, and matrix 1030 corresponds to 16 kB. That is, the outer product GPR cost for input matrix tiles A (matrix 1010) and B (matrix 1020) is small, while storage for matrix C (matrix 1030) is large. Diagram 1000 in FIG. 10 assumes 32-bit input data in each square of the input and output. As shown in FIG. 10, for outer-product based matrix multiplication engines, the bulk of a storage utilization comes from the size of the output matrix C (matrix 1030), since larger output matrices imply a larger outer product and better input data reuse. However, large output matrix storage may be costly in GPR in register allocation, bandwidth, and power.

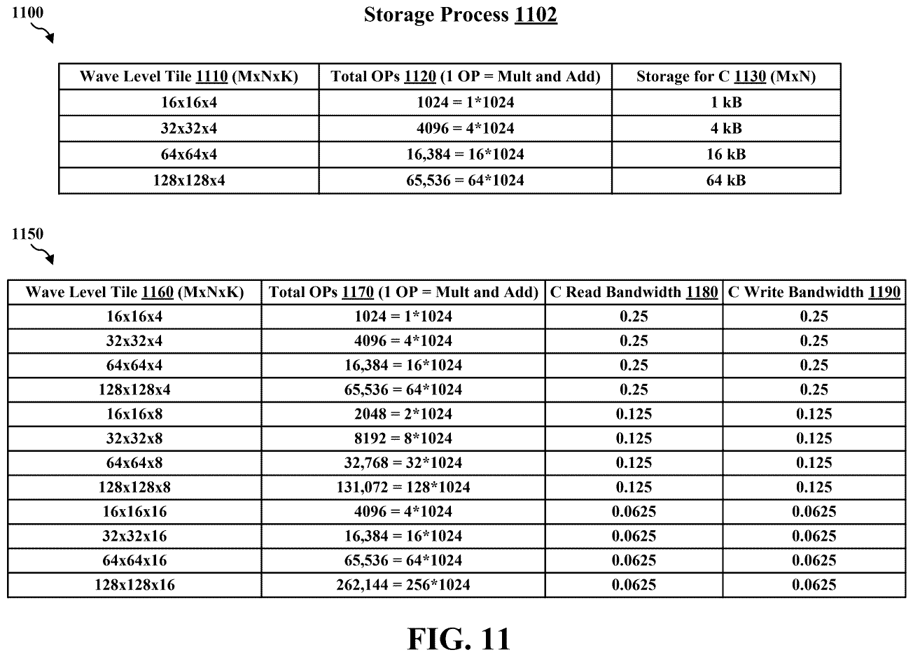

FIG. 11 illustrates diagrams including one example of a storage process. More specifically, diagram 1100 and diagram 1150 depicts an example storage process 1102 at a GPU. Diagram 1100 includes wave level tile 1110 (M×N×K), total operations 1120 (where 1 operation=multiply and add), and storage for matrix C 1130 (M×N matrix). As shown in FIG. 11, the diagram 1100 demonstrates the GPR size limitations of storing the C matrix in GPR. As the wave-level tile size increases in the M and N directions (where K is 4 in diagram 1100 for M×N×K), the storage utilization increases quadratically. That is, as the C matrix tile size increases in the M and N dimension, the storage utilization grows quadratically limiting the number of concurrent waves on the shader processor. For example, for a wave level tile of 16×16×4, the total number of operations is 1024, and the storage for matrix C is 1 kB. Also, for a wave level tile of 32×32×4, the total number of operations is 4096=4*1024, and the storage for matrix C is 4 kB. Further, for a wave level tile of 64×64×4, the total number of operations is 16,384=16*1024, and the storage for matrix C is 16 kB. Moreover, for a wave level tile of 128×128×4, the total number of operations is 65,536=64*1024, and the storage for matrix C is 64 kB.

Diagram 1150 includes wave level tile 1160 (M×N×K), total operations 1170 (where 1 operation=multiply and add), a matrix C read bandwidth 1180, and a matrix C write bandwidth 1190. Diagram 1150 in FIG. 11 illustrates the GPR read and write bandwidth pressure of accessing the C matrix in GPR. One way to mitigate the C read bandwidth and C write bandwidth condition is to increase input tiles in the K direction. However, this may create additional constraints such as larger input tile buffering and storage. Further, diagram 1150 depicts that the matrix multiplication on GPU has a high GPR bandwidth condition to read and write intermediate outputs of matrix C to the GPR. This can be mitigated by increasing the step K of each tile, but that approach may add a secondary constraint on input tile buffering. As shown in diagram 1150, for a wave level tile of 128×128×4, the total number of operations is 65,536=64*1024, and the matrix C read and write bandwidth is 0.25. Also, for a wave level tile of 16×16×8, the total number of operations is 2048=2*1024, and the matrix C read and write bandwidth is 0.125. Additionally, for a wave level tile of 32×32×8, the total number of operations is 8192=8*1024, and the matrix C read and write bandwidth is 0.125. Moreover, for a wave level tile of 128×128×8, the total number of operations is 131,072=128*1024, and the matrix C read and write bandwidth is 0.125. Further, for a wave level tile of 128×128×16, the total number of operations is 262,144=256*1024, and the matrix C read and write bandwidth is 0.0625.

As noted herein, the existing industry storage and read/write bandwidth choice for output matrix C is in the GPR. That is, most of this storage utilization from the result of this matrix multiplication is from the output matrix C. And the issue is that by storing all of the matrix C output in GPR, then the GPR gets backlogged. So the problem is that the storage and use of the read write bandwidth for the output matrix C for matrix multiplication is in the GPR. And the sole way to mitigate GPR read and write bandwidth penalty is to increase the accumulation steps in the K dimension (where K is the number of computations that are needed for each M and N combination). However, by doing so, performance and power at the GPU is expected to degrade as the tile step-size in the K dimension increases. Based on the above, it may be beneficial to optimize or improve a GPU's ability to handle data storage for certain operations. That is, it may be beneficial to allow a GPU to optimize a storage capability for matrix multiplication. For instance, it may be beneficial to utilize a separate storage unit at a GPU for matrix multiplication, rather than the GPR. It may also be beneficial to utilize the GPR for other storage issues in parallel with the matrix multiplication process. It may also be beneficial to reduce the amount of power consumption at the GPR.

Aspects of the present disclosure may optimize or improve a GPU's ability to handle data storage for certain operations. For instance, aspects presented herein may allow a GPU to optimize a storage capability for matrix multiplication. That is, aspects presented herein may utilize a separate storage unit at a GPU for matrix multiplication. Indeed, aspects presented herein may utilize a per-wave storage space that is adjacent to the matrix multiplication engines at the GPU. For example, aspects herein may utilize localized wave-level output storage for GPU-based matrix multiplication. Also, aspects herein may move certain storage closer to the matrix multiplication engines in the GPU. Aspects presented herein may also utilize the GPR for other storage issues in parallel with the matrix multiplication process. In turn, this may allow a GPU to reduce the amount of power consumption at the GPR. By doing so, aspects presented herein may allow a GPU to optimize power consumption and storage capability. In turn, this may optimize or improve the overall performance of a GPU.

Aspects presented herein may utilize a method for reducing storage utilization at GPUs for GPU-based matrix multiplication by implementing certain types of storage (e.g., localized wave-level output storage). By utilizing wave-level output storage, this may minimize the need for extensive register allocation and reduce bandwidth and power consumption at the GPU. In turn, this may address cost concerns associated with storing the output matrix C. Aspects herein propose a persistent per-wave storage space close to the matrix multiplication engine in a GPU, which can be allocated on a per-wave manner and store partial output matrix C results for a duration of an accumulation sequence. By doing so, this may reduce GPR pressure by allowing more waves to run in parallel. GPR pressure is a common problem in GPU programming, so any reduction in GPR pressure is welcome at GPUs. Additionally, aspects herein may use the GPR in parallel for other storage and bandwidth issues. Aspects herein may move accumulation storage close to the matrix multiplication processing elements in order to reduce GPR power consumption and dramatically drops the read/write bandwidth utilization at a GPU.

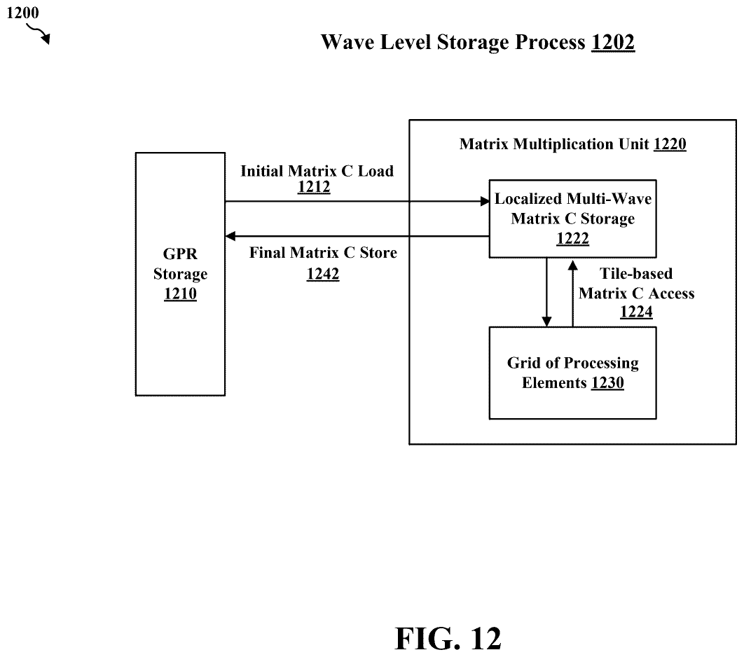

Aspects presented herein may also utilize certain memory (e.g., localized, persistent, wave-level storage) for matrix multiplication. By utilizing certain storage for matrix multiplication, the run-time condition of accessing output matrix C data may be offloaded to internal storage close to the matrix multiplication processing elements. Additionally, the storage size and high bandwidth access constraints may be offloaded to internal memory for an entire duration of an accumulation loop. In an ideal scenario, as depicted in FIG. 12 below, the localized storage may be written and read once at the start and end of the accumulation loop. As such, aspects herein may utilize local storage for matrix multiplication, as well as utilize the local storage in a manner that minimizes GPU processing and bandwidth.

In some instances, aspects presented herein may utilize localized persistent wave level storage. With this type of internal storage, the runtime condition for output matrix C data may be offloaded to this internal storage close to matrix multiplication. So rather than overloading the read and write bandwidth to GPR or increasing the amount of K tiles, aspects herein may offload this problem into a localized storage, which is much less costly to access compared to GPR. Also, the storage size and high bandwidth access constraints may be temporarily offloaded to the internal memory storage, such that they are not offloaded for the entire duration of the accumulation loop. Aspects herein may take advantage of the entire accumulation known as a stationary accumulation. So in one scenario, the localized storage may be written one time, once at the beginning and once at the end of the accumulation loop. The localized storage may be added as part of the matrix multiplication unit at a GPU. So this is integrated into the matrix multiplication unit and it may be tightly coupled with the processing elements. Aspects presented herein may load this storage once at the beginning of the loop, which is initial value of output matrix C (e.g., zero or some constant). In a high bandwidth situation, aspects herein may need to access the local storage in sequences for the whole accumulation loop. After this, such as later in the accumulation loop (e.g., after 1000 accumulations), may be the final store. The local storage may be read into written into one time, such as once at the beginning of the accumulation and once at the end. So it really depends on the number of total accumulation loops, as the more loops there are, the benefit grows significantly. In addition to the read and write bandwidth reduction, aspects herein may also provide for a GPR savings. So for the duration of the loop, aspects herein may deallocate this space in GPR once the original initial value of output matrix C has been loaded into the local storage. While this process is happening, the GPR space can be freed up and used for other operations and storage in parallel. So aspects herein may relieve GPR storage pressure and relieve GPR read and write bandwidth at the GPU.

Aspects presented herein (e.g., a GPU or a shader processor (SP) in a GPU) may obtain a first wave of first data associated with graphics processing, where an allocation of a portion of a storage unit is based on the obtainment. Aspects presented herein (e.g., a GPU or a SP in a GPU) may also allocate a portion of a storage unit for a first wave of first data, where the first data represents a block of output data. Aspects presented herein (e.g., a GPU or a SP in a GPU) may also store the first wave of the first data as an initial accumulator value for a matrix multiplication accumulation process. Additionally, aspects presented herein (e.g., a GPU or a SP in a GPU) may process the first data and second data included in the first wave, where the second data represents a block of input data. Aspects presented herein (e.g., a GPU or a SP in a GPU) may also update the initial accumulator value of the first data to be an updated accumulator value of the first data based on a result of the processing of the first data and the second data. Aspects presented herein (e.g., a GPU or a SP in a GPU) may also provide an indication of the updated accumulator value of the first data to at least one other component in a graphics processing unit (GPU). Moreover, aspects presented herein (e.g., a GPU or a SP in a GPU) may allocate a second portion of the storage unit for a second wave of third data. Aspects presented herein (e.g., a GPU or a SP in a GPU) may also store the second wave of the third data as a second initial accumulator value for the matrix multiplication accumulation process. Aspects presented herein (e.g., a GPU or a SP in a GPU) may also process the third data and fourth data included in the second wave. Aspects presented herein (e.g., a GPU or a SP in a GPU) may also update the second initial accumulator value of the third data based on a result of the processing of the third data and the fourth data. Aspects presented herein (e.g., a GPU or a SP in a GPU) may also store the updated accumulator value of the first data to a general purpose register (GPR). Aspects presented herein (e.g., a GPU or a SP in a GPU) may also deallocate the portion of the storage unit for the first wave of the first data based on the storage of the updated accumulator value of the first data. Aspects presented herein (e.g., a GPU or a SP in a GPU) may also output an indication of a result of the processing of the first data and the second data.

FIG. 12 illustrates diagrams including one example of a wave level storage process. More specifically, diagram 1200 depicts an example wave level storage process 1202 at a GPU. Diagram 1200 includes GPR storage 1210, initial matrix C load 1212 (where matrix C is an output matrix for matrix multiplication at a GPU), matrix multiplication unit 1220, localized multi-wave matrix C storage 1222, tile-based matrix C access 1224, grid of processing elements 1230, and final matrix C store 1242. As shown in FIG. 12, GPR storage 1210 may send initial matrix C load 1212 to localized multi-wave matrix C storage 1222. The tile-based matrix C access 1224 may be transferred from localized multi-wave matrix C storage 1222 to grid of processing elements 1230. Further, the tile-based matrix C access 1224 may be transferred from grid of processing elements 1230 to localized multi-wave matrix C storage 1222. The final matrix C store 1242 may be sent from localized multi-wave matrix C storage 1222 to GPR storage 1210. As shown in FIG. 12, aspects herein may add a localized, wave-level storage for matrix C (e.g., localized multi-wave matrix C storage 1222) to matrix multiplication unit 1220. Also, the initial value of matrix C (e.g., initial matrix C load 1212) and final value of matrix C (e.g., final matrix C store 1242) may be read and written once from GPR storage 1210. The rest of the accesses may be local to the matrix multiplication unit 1220.

As depicted in FIG. 12, aspects presented herein may also utilize certain memory (e.g., localized multi-wave matrix C storage 1222) for matrix multiplication at a GPU (e.g., using matrix multiplication unit 1220). By utilizing certain storage for matrix multiplication (e.g., localized multi-wave matrix C storage 1222), the run-time condition of accessing output matrix C data may be offloaded to internal storage close to the grid of processing elements 1230 in matrix multiplication unit 1220. Additionally, the storage size and high bandwidth access constraints may be offloaded to internal memory (e.g., localized multi-wave matrix C storage 1222) for an entire duration of an accumulation loop. In an ideal scenario, as depicted in FIG. 12, the localized storage (e.g., localized multi-wave matrix C storage 1222) may be written and read once at the start and end of the accumulation loop. That is, the initial value of matrix C (e.g., initial matrix C load 1212) and final value of matrix C (e.g., final matrix C store 1242) may be read and written once from GPR storage 1210. As such, aspects herein may utilize local storage (e.g., localized multi-wave matrix C storage 1222) in matrix multiplication unit 1220, as well as utilize the local storage in a manner that minimizes GPU processing and bandwidth.

Additionally, aspects presented herein may achieve GPR read and write bandwidth reduction with persistent wave-level matrix C storage. This persistent wave-level matrix C storage may be part of the matrix multiplication unit at a GPU. That is, GPR read and write bandwidth reduction may be achieved with persistent wave-level storage of data for output matrix C for matrix multiplication. For a total number of tiles (i.e., a number of accumulation loops), aspects herein may achieve a certain percentage of GPR read and write bandwidth reduction for data for output matrix C. For example, for 2 tiles, aspects herein may achieve a GPR read and write bandwidth reduction of 50% for output matrix C. For 4 tiles, aspects herein may achieve a GPR read and write bandwidth reduction of 75% for output matrix C. For 8 tiles, aspects herein may achieve a GPR read and write bandwidth reduction of 87.5% for output matrix C. For 16 tiles, aspects herein may achieve a GPR read and write bandwidth reduction of 93.75% for output matrix C. For 32 tiles, aspects herein may achieve a GPR read and write bandwidth reduction of 96.88% for output matrix C. For 64 tiles, aspects herein may achieve a GPR read and write bandwidth reduction of 98.44% for output matrix C. For 128 tiles, aspects herein may achieve a GPR read and write bandwidth reduction of 99.22% for output matrix C.

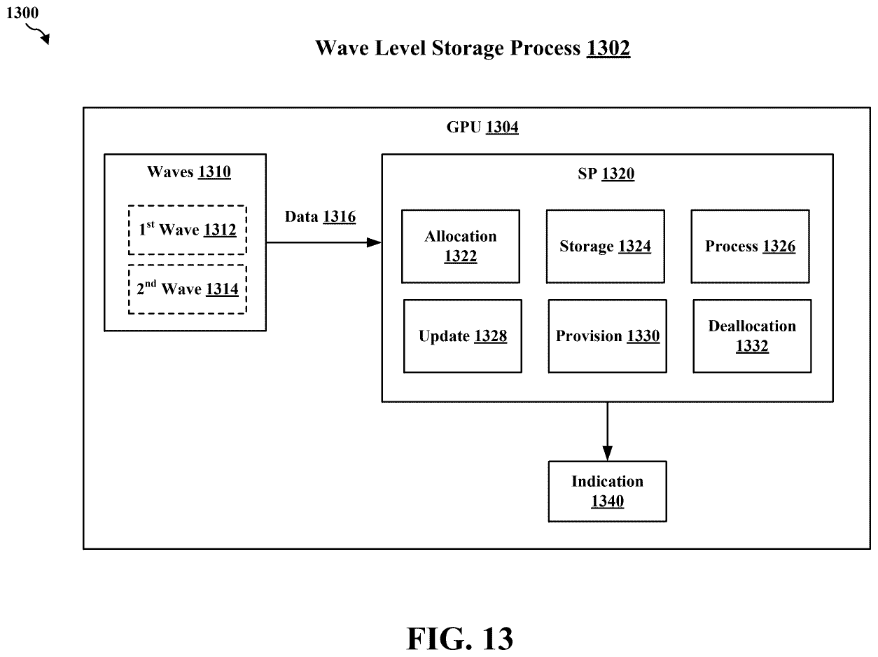

FIG. 13 illustrates diagram 1300 including an example traversal process. More specifically, diagram 1300 depicts one example of a traversal process 1302 within a GPU 1304. As shown in FIG. 13, diagram 1300 includes GPU 1304, waves 1310 including first wave 1312 and second wave 1314, indication 1316, SP 1320, allocation component 1322, storage component 1324, process component 1326, update component 1328, provision component 1330, deallocation component 1332, and indication 1340. As shown in FIG. 13, SP 1320 may obtain a first wave of first data associated with graphics processing, where an allocation of a portion of a storage unit is based on the obtainment. SP 1320 may also allocate (e.g., via allocation component 1322) a portion of a storage unit for a first wave of first data, where the first data represents a block of output data. SP 1320 may also store (e.g., via storage component 1324) the first wave of the first data as an initial accumulator value for a matrix multiplication accumulation process. SP 1320 may also process (e.g., via process component 1326) the first data and second data included in the first wave, where the second data represents a block of input data. SP 1320 may also update (e.g., via update component 1328) the initial accumulator value of the first data to be an updated accumulator value of the first data based on a result of the processing of the first data and the second data. SP 1320 may also provide (e.g., via provision component 1330) an indication 1340 of the updated accumulator value of the first data to at least one other component in a graphics processing unit (GPU). SP 1320 may also allocate (e.g., via allocation component 1322) a second portion of the storage unit for a second wave of third data. SP 1320 may also store (e.g., via storage component 1324) the second wave of the third data as a second initial accumulator value for the matrix multiplication accumulation process. SP 1320 may also process (e.g., via process component 1326) the third data and fourth data included in the second wave. SP 1320 may also update (e.g., via update component 1328) the second initial accumulator value of the third data based on a result of the processing of the third data and the fourth data. SP 1320 may also store (e.g., via storage component 1324) the updated accumulator value of the first data to a general purpose register (GPR). SP 1320 may also deallocate (e.g., via deallocation component 1332) the portion of the storage unit for the first wave of the first data based on the storage of the updated accumulator value of the first data. SP 1320 may also output an indication 1340 of a result of the processing of the first data and the second data.

Aspects of the present disclosure may include a number of benefits or advantages. For instance, aspects of the present disclosure may optimize or improve a GPU's ability to handle data storage for certain operations. Aspects presented herein may allow a GPU to optimize a storage capability for matrix multiplication. That is, aspects presented herein may utilize a separate storage unit at a GPU for matrix multiplication. Indeed, aspects presented herein may utilize a per-wave storage space that is adjacent to the matrix multiplication engines at the GPU. For example, aspects herein may utilize localized wave-level output storage for GPU-based matrix multiplication. Also, aspects herein may move certain storage closer to the matrix multiplication engines in the GPU. Aspects presented herein may also utilize the GPR for other storage issues in parallel with the matrix multiplication process. In turn, this may allow a GPU to reduce the amount of power consumption at the GPR. By doing so, aspects presented herein may allow a GPU to optimize power consumption and storage capability. In turn, this may optimize or improve the overall performance of a GPU.

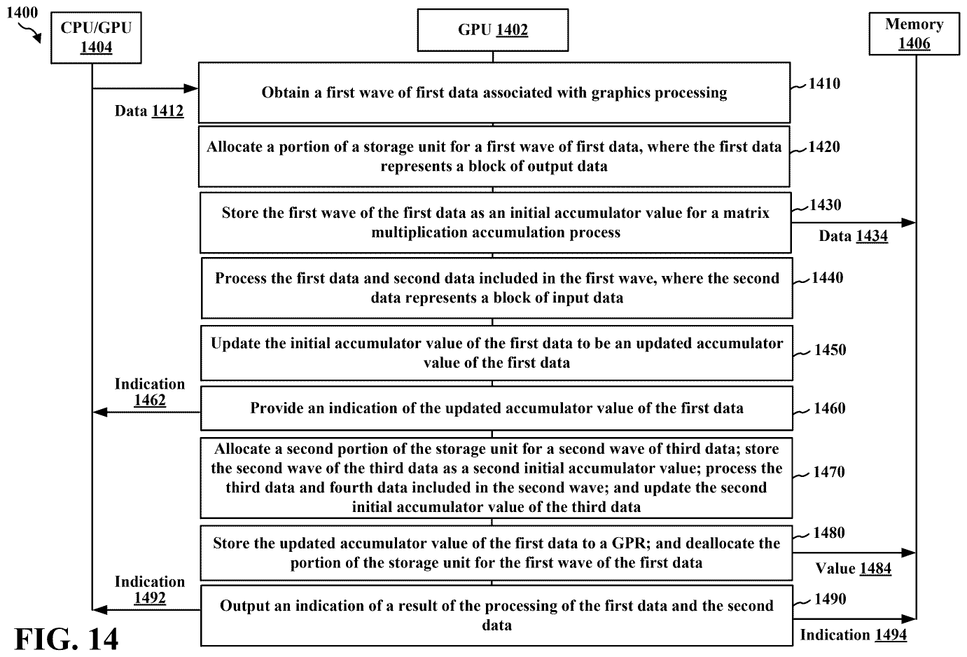

FIG. 14 is a communication flow diagram 1400 of graphics processing in accordance with one or more techniques of this disclosure. As shown in FIG. 14, diagram 1400 includes example communications between GPU 1402 (e.g., a GPU, a graphics pipeline at a GPU, a shader processor at a GPU, a streaming processor at a GPU, a GPU component, another graphics processor, a CPU, a CPU component, or another central processor), CPU/GPU 1404 (e.g., a CPU, a CPU component, or another central processor, a GPU, a graphics pipeline at a GPU, a shader processor at a GPU, a GPU component, or another graphics processor), and memory 1406 (e.g., a memory, a cache, a system memory, a graphics memory, a memory or cache at a CPU, or a memory or cache at a GPU), in accordance with one or more techniques of this disclosure.

At 1410, GPU 1402 may obtain a first wave of first data associated with graphics processing, where an allocation of a portion of a storage unit is based on the obtainment. For example, GPU 1402 may obtain data 1412 from CPU/GPU 1404. In some aspects, obtaining the first wave of the first data may comprise receiving, from a general purpose register (GPR) at a shader processor (SP) of a graphics processing unit (GPU), the first wave of the first data.

At 1420, GPU 1402 may allocate a portion of a storage unit for a first wave of first data, where the first data represents a block of output data. In some aspects, allocating the portion of the storage unit for the first wave of the first data may comprise allocating the portion of an accumulator storage unit for the first wave of the first data, where the accumulator storage unit is for the matrix multiplication accumulation process. Also, the allocation of the portion of the accumulator storage unit may be a persistent allocation of a shared storage for the matrix multiplication accumulation process.

At 1430, GPU 1402 may store the first wave of the first data as an initial accumulator value for a matrix multiplication accumulation process. For example, GPU 1402 may store data 1434 in memory 1406. In some aspects, storing the first wave of the first data as the initial accumulator value may comprise loading, into the storage unit for the matrix multiplication accumulation process, the first wave of the first data as the initial accumulator value, where the storage unit is an accumulator storage unit. Also, loading, into the accumulator storage unit, the first wave of the first data as the initial accumulator value may comprise loading, into the accumulator storage unit in a matrix multiplication unit (MMU) at a shader processor (SP) of a graphics processing unit (GPU), the first wave of the first data as the initial accumulator value. In some instances, the first data may be associated with a matrix C for the matrix multiplication accumulation process. Also, the second data may be associated with a matrix A and a matrix B for the matrix multiplication accumulation process.

At 1440, GPU 1402 may process the first data and second data included in the first wave, where the second data represents a block of input data. In some aspects, processing the first data and the second data may comprise processing, at a set of processing elements in a matrix multiplication unit (MMU) at a shader processor (SP) of a graphics processing unit (GPU), the first data and the second data. Additionally, the first data may be accumulator data for the matrix multiplication accumulation process.

At 1450, GPU 1402 may update the initial accumulator value of the first data to be an updated accumulator value of the first data based on a result of the processing of the first data and the second data. In some aspects, updating the initial accumulator value of the first data based on the result of the processing of the first data and the second data may comprise loading, into the storage unit, the result of the processing of the first data and the second data. Also, loading, into the storage unit, the result of the processing of the first data and the second data may comprise writing, into the storage unit, the result of the processing of the first data and the second data.

At 1460, GPU 1402 may provide an indication of the updated accumulator value of the first data to at least one other component in a graphics processing unit (GPU). For example, GPU 1402 may provide indication 1462 to CPU/GPU 1404.

At 1470, GPU 1402 may allocate a second portion of the storage unit for a second wave of third data. Also, at 1470, GPU 1402 may store the second wave of the third data as a second initial accumulator value for the matrix multiplication accumulation process. Also, at 1470, GPU 1402 may process the third data and fourth data included in the second wave. Also, at 1470, GPU 1402 may update the second initial accumulator value of the third data based on a result of the processing of the third data and the fourth data.

At 1480, GPU 1402 may store the updated accumulator value of the first data to a general purpose register (GPR). For example, GPU 1402 may store value 1484 in memory 1406. Also, at 1480, GPU 1402 may deallocate the portion of the storage unit for the first wave of the first data based on the storage of the updated accumulator value of the first data.

At 1490, GPU 1402 may output an indication of a result of the processing of the first data and the second data. In some aspects, outputting the indication of the result of the processing of the first data and the second data may comprise transmitting the indication of the result of the processing of the first data and the second data. For example, GPU 1402 may transmit indication 1492 to CPU/GPU 1404. Also, outputting the indication of the result of the processing of the first data and the second data may comprise storing the indication of the result of the processing of the first data and the second data. For example, GPU 1402 may store indication 1494 in memory 1406.

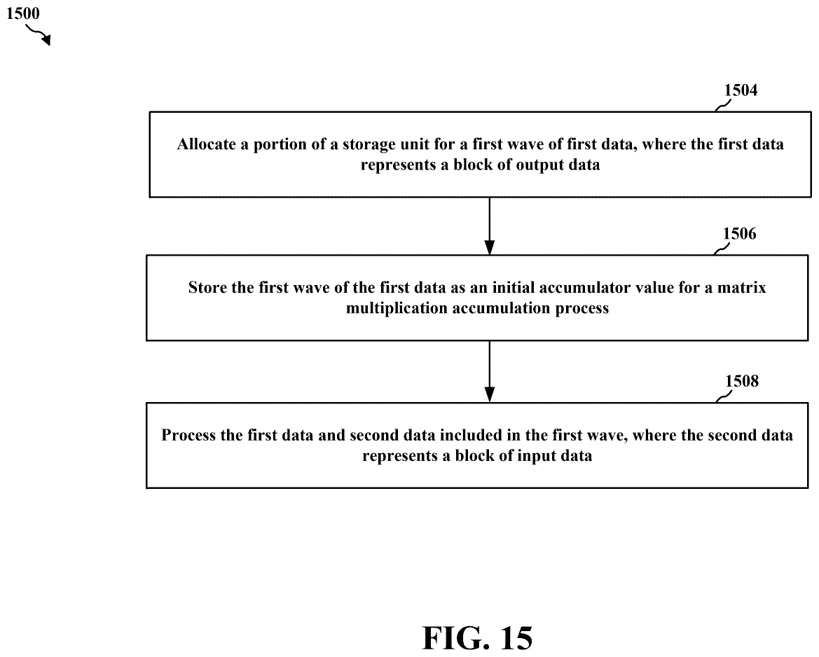

FIG. 15 is a flowchart 1500 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-14.

At 1504, the GPU may allocate a portion of a storage unit for a first wave of first data, where the first data represents a block of output data, as described in connection with the examples in FIGS. 1-14. For example, as described in 1420 of FIG. 14, GPU 1402 may allocate a portion of a storage unit for a first wave of first data, where the first data represents a block of output data. Further, step 1504 may be performed by processing unit 120 in FIG. 1. In some aspects, allocating the portion of the storage unit for the first wave of the first data may comprise allocating the portion of an accumulator storage unit for the first wave of the first data, where the accumulator storage unit is for the matrix multiplication accumulation process. Also, the allocation of the portion of the accumulator storage unit may be a persistent allocation of a shared storage for the matrix multiplication accumulation process.

At 1506, the GPU may store the first wave of the first data as an initial accumulator value for a matrix multiplication accumulation process, as described in connection with the examples in FIGS. 1-14. For example, as described in 1430 of FIG. 14, GPU 1402 may store the first wave of the first data as an initial accumulator value for a matrix multiplication accumulation process. Further, step 1506 may be performed by processing unit 120 in FIG. 1. For example, GPU 1402 may store data 1434 in memory 1406. In some aspects, storing the first wave of the first data as the initial accumulator value may comprise loading, into the storage unit for the matrix multiplication accumulation process, the first wave of the first data as the initial accumulator value, where the storage unit is an accumulator storage unit. Also, loading, into the accumulator storage unit, the first wave of the first data as the initial accumulator value may comprise loading, into the accumulator storage unit in a matrix multiplication unit (MMU) at a shader processor (SP) of a graphics processing unit (GPU), the first wave of the first data as the initial accumulator value. In some instances, the first data may be associated with a matrix C for the matrix multiplication accumulation process. Also, the second data may be associated with a matrix A and a matrix B for the matrix multiplication accumulation process.

At 1508, the GPU may process the first data and second data included in the first wave, where the second data represents a block of input data, as described in connection with the examples in FIGS. 1-14. For example, as described in 1440 of FIG. 14, GPU 1402 may process the first data and second data included in the first wave, where the second data represents a block of input data. Further, step 1508 may be performed by processing unit 120 in FIG. 1. In some aspects, processing the first data and the second data may comprise processing, at a set of processing elements in a matrix multiplication unit (MMU) at a shader processor (SP) of a graphics processing unit (GPU), the first data and the second data. Additionally, the first data may be accumulator data for the matrix multiplication accumulation process.

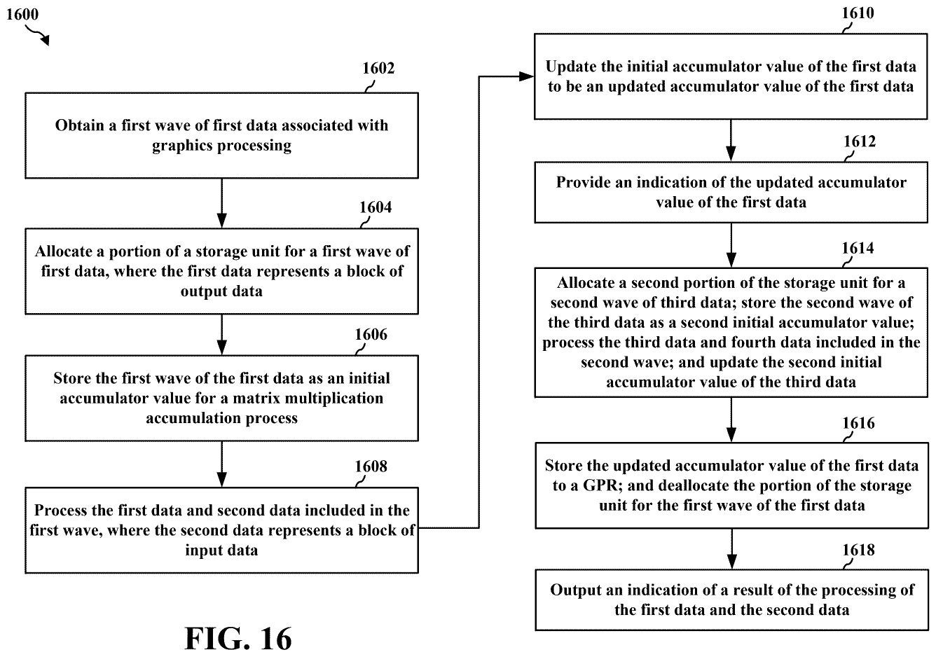

FIG. 16 is a flowchart 1600 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-14.

At 1602, the GPU may obtain a first wave of first data associated with graphics processing, where an allocation of a portion of a storage unit is based on the obtainment, as described in connection with the examples in FIGS. 1-14. For example, as described in 1410 of FIG. 14, GPU 1402 may obtain a first wave of first data associated with graphics processing, where an allocation of a portion of a storage unit is based on the obtainment. Further, step 1602 may be performed by processing unit 120 in FIG. 1. For example, GPU 1402 may obtain data 1412 from CPU/GPU 1404. In some aspects, obtaining the first wave of the first data may comprise receiving, from a general purpose register (GPR) at a shader processor (SP) of a graphics processing unit (GPU), the first wave of the first data.

At 1604, the GPU may allocate a portion of a storage unit for a first wave of first data, where the first data represents a block of output data, as described in connection with the examples in FIGS. 1-14. For example, as described in 1420 of FIG. 14, GPU 1402 may allocate a portion of a storage unit for a first wave of first data, where the first data represents a block of output data. Further, step 1604 may be performed by processing unit 120 in FIG. 1. In some aspects, allocating the portion of the storage unit for the first wave of the first data may comprise allocating the portion of an accumulator storage unit for the first wave of the first data, where the accumulator storage unit is for the matrix multiplication accumulation process. Also, the allocation of the portion of the accumulator storage unit may be a persistent allocation of a shared storage for the matrix multiplication accumulation process.

At 1606, the GPU may store the first wave of the first data as an initial accumulator value for a matrix multiplication accumulation process, as described in connection with the examples in FIGS. 1-14. For example, as described in 1430 of FIG. 14, GPU 1402 may store the first wave of the first data as an initial accumulator value for a matrix multiplication accumulation process. Further, step 1606 may be performed by processing unit 120 in FIG. 1. For example, GPU 1402 may store data 1434 in memory 1406. In some aspects, storing the first wave of the first data as the initial accumulator value may comprise loading, into the storage unit for the matrix multiplication accumulation process, the first wave of the first data as the initial accumulator value, where the storage unit is an accumulator storage unit. Also, loading, into the accumulator storage unit, the first wave of the first data as the initial accumulator value may comprise loading, into the accumulator storage unit in a matrix multiplication unit (MMU) at a shader processor (SP) of a graphics processing unit (GPU), the first wave of the first data as the initial accumulator value. In some instances, the first data may be associated with a matrix C for the matrix multiplication accumulation process. Also, the second data may be associated with a matrix A and a matrix B for the matrix multiplication accumulation process.

At 1608, the GPU may process the first data and second data included in the first wave, where the second data represents a block of input data, as described in connection with the examples in FIGS. 1-14. For example, as described in 1440 of FIG. 14, GPU 1402 may process the first data and second data included in the first wave, where the second data represents a block of input data. Further, step 1608 may be performed by processing unit 120 in FIG. 1. In some aspects, processing the first data and the second data may comprise processing, at a set of processing elements in a matrix multiplication unit (MMU) at a shader processor (SP) of a graphics processing unit (GPU), the first data and the second data. Additionally, the first data may be accumulator data for the matrix multiplication accumulation process.

At 1610, the GPU may update the initial accumulator value of the first data to be an updated accumulator value of the first data based on a result of the processing of the first data and the second data, as described in connection with the examples in FIGS. 1-14. For example, as described in 1450 of FIG. 14, GPU 1402 may update the initial accumulator value of the first data to be an updated accumulator value of the first data based on a result of the processing of the first data and the second data. Further, step 1610 may be performed by processing unit 120 in FIG. 1. In some aspects, updating the initial accumulator value of the first data based on the result of the processing of the first data and the second data may comprise loading, into the storage unit, the result of the processing of the first data and the second data. Also, loading, into the storage unit, the result of the processing of the first data and the second data may comprise writing, into the storage unit, the result of the processing of the first data and the second data.

At 1612, the GPU may provide an indication of the updated accumulator value of the first data to at least one other component in a graphics processing unit (GPU), as described in connection with the examples in FIGS. 1-14. For example, as described in 1460 of FIG. 14, GPU 1402 may provide an indication of the updated accumulator value of the first data to at least one other component in a graphics processing unit (GPU). Further, step 1612 may be performed by processing unit 120 in FIG. 1. For example, GPU 1402 may provide indication 1462 to CPU/GPU 1404.

At 1614, the GPU may allocate a second portion of the storage unit for a second wave of third data, as described in connection with the examples in FIGS. 1-14. For example, as described in 1470 of FIG. 14, GPU 1402 may allocate a second portion of the storage unit for a second wave of third data. Also, at 1614, the GPU may store the second wave of the third data as a second initial accumulator value for the matrix multiplication accumulation process, as described in connection with the examples in FIGS. 1-14. For example, as described in 1470 of FIG. 14, GPU 1402 may store the second wave of the third data as a second initial accumulator value for the matrix multiplication accumulation process. Also, at 1614, the GPU may process the third data and fourth data included in the second wave, as described in connection with the examples in FIGS. 1-14. For example, as described in 1470 of FIG. 14, GPU 1402 may process the third data and fourth data included in the second wave. Also, at 1614, the GPU may update the second initial accumulator value of the third data based on a result of the processing of the third data and the fourth data, as described in connection with the examples in FIGS. 1-14. For example, as described in 1470 of FIG. 14, GPU 1402 may update the second initial accumulator value of the third data based on a result of the processing of the third data and the fourth data. Further, step 1614 may be performed by processing unit 120 in FIG. 1.

At 1616, the GPU may store the updated accumulator value of the first data to a general purpose register (GPR), as described in connection with the examples in FIGS. 1-14. For example, as described in 1480 of FIG. 14, GPU 1402 may store the updated accumulator value of the first data to a general purpose register (GPR). Further, step 1616 may be performed by processing unit 120 in FIG. 1. For example, GPU 1402 may store value 1484 in memory 1406. Also, at 1616, the GPU may deallocate the portion of the storage unit for the first wave of the first data based on the storage of the updated accumulator value of the first data, as described in connection with the examples in FIGS. 1-14. For example, as described in 1480 of FIG. 14, GPU 1402 may deallocate the portion of the storage unit for the first wave of the first data based on the storage of the updated accumulator value of the first data. Further, step 1616 may be performed by processing unit 120 in FIG. 1.

At 1618, the GPU may output an indication of a result of the processing of the first data and the second data, as described in connection with the examples in FIGS. 1-14. For example, as described in 1490 of FIG. 14, GPU 1402 may output an indication of a result of the processing of the first data and the second data. Further, step 1618 may be performed by processing unit 120 in FIG. 1. In some aspects, outputting the indication of the result of the processing of the first data and the second data may comprise transmitting the indication of the result of the processing of the first data and the second data. For example, GPU 1402 may transmit indication 1492 to CPU/GPU 1404. Also, outputting the indication of the result of the processing of the first data and the second data may comprise storing the indication of the result of the processing of the first data and the second data. For example, GPU 1402 may store indication 1494 in memory 1406.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for allocating a portion of a storage unit for a first wave of first data, where the first data represents a block of output data. The apparatus, e.g., processing unit 120, may also include means for storing the first wave of the first data as an initial accumulator value for a matrix multiplication accumulation process. The apparatus, e.g., processing unit 120, may also include means for processing the first data and second data included in the first wave, where the second data represents a block of input data. The apparatus, e.g., processing unit 120, may also include means for updating the initial accumulator value of the first data to be an updated accumulator value of the first data based on a result of the processing of the first data and the second data. The apparatus, e.g., processing unit 120, may also include means for allocating a second portion of the storage unit for a second wave of third data. The apparatus, e.g., processing unit 120, may also include means for storing the second wave of the third data as a second initial accumulator value for the matrix multiplication accumulation process. The apparatus, e.g., processing unit 120, may also include means for processing the third data and fourth data included in the second wave. The apparatus, e.g., processing unit 120, may also include means for updating the second initial accumulator value of the third data based on a result of the processing of the third data and the fourth data. The apparatus, e.g., processing unit 120, may also include means for storing the updated accumulator value of the first data to a general purpose register (GPR). The apparatus, e.g., processing unit 120, may also include means for deallocating the portion of the storage unit for the first wave of the first data based on the storage of the updated accumulator value of the first data. The apparatus, e.g., processing unit 120, may also include means for providing an indication of the updated accumulator value of the first data to at least one other component in a graphics processing unit (GPU). The apparatus, e.g., processing unit 120, may also include means for obtaining the first wave of the first data associated with the graphics processing, where the allocation of the portion of the storage unit is based on the obtainment. The apparatus, e.g., processing unit 120, may also include means for outputting an indication of a result of the processing of the first data and the second data.

The subject matter described herein may be implemented to realize one or more benefits or advantages. For instance, the described graphics processing techniques may be used by a GPU, a shader processor, a streaming processor, a CPU, a central processor, or some other processor that may perform graphics processing to implement the output storage techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize output storage techniques in order to improve memory bandwidth efficiency and/or increase processing speed at a GPU, a shader processor, a CPU, or a display processing unit (DPU).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is an apparatus for graphics processing, including at least one memory; and at least one processor coupled to the at least one memory and, based at least in part on information stored in the at least one memory, the at least one processor, individually or in any combination, is configured to: allocate a portion of a storage unit for a first wave of first data, wherein the first data represents a block of output data; store the first wave of the first data as an initial accumulator value for a matrix multiplication accumulation process; and process the first data and second data included in the first wave, wherein the second data represents a block of input data.
Aspect 2 is the apparatus of aspect 1, wherein the at least one processor is further configured to: update the initial accumulator value of the first data to be an updated accumulator value of the first data based on a result of the processing of the first data and the second data.
Aspect 3 is the apparatus of aspect 2, wherein to update the initial accumulator value of the first data based on the result of the processing of the first data and the second data, the at least one processor is configured to: load, into the storage unit, the result of the processing of the first data and the second data.
Aspect 4 is the apparatus of aspect 3, wherein to load, into the storage unit, the result of the processing of the first data and the second data, the at least one processor is configured to: write, into the storage unit, the result of the processing of the first data and the second data.
Aspect 5 is the apparatus of any of aspects 2 to 4, wherein the at least one processor is further configured to: allocate a second portion of the storage unit for a second wave of third data; store the second wave of the third data as a second initial accumulator value for the matrix multiplication accumulation process; and process the third data and fourth data included in the second wave.
Aspect 6 is the apparatus of aspect 5, wherein the at least one processor is further configured to: update the second initial accumulator value of the third data based on a result of the processing of the third data and the fourth data.
Aspect 7 is the apparatus of any of aspects 2 to 6, wherein the at least one processor is further configured to: store the updated accumulator value of the first data to a general purpose register (GPR).
Aspect 8 is the apparatus of aspect 7, wherein the at least one processor is further configured to: deallocate the portion of the storage unit for the first wave of the first data based on the storage of the updated accumulator value of the first data.
Aspect 9 is the apparatus of any of aspects 2 to 8, wherein the at least one processor is further configured to: provide an indication of the updated accumulator value of the first data to at least one other component in a graphics processing unit (GPU).
Aspect 10 is the apparatus of any of aspects 1 to 9, wherein to allocate the portion of the storage unit for the first wave of the first data, the at least one processor is configured to: allocate the portion of an accumulator storage unit for the first wave of the first data, wherein the accumulator storage unit is for the matrix multiplication accumulation process.
Aspect 11 is the apparatus of aspect 10, wherein the allocation of the portion of the accumulator storage unit is a persistent allocation of a shared storage for the matrix multiplication accumulation process.
Aspect 12 is the apparatus of any of aspects 1 to 11, wherein to store the first wave of the first data as the initial accumulator value, the at least one processor is configured to: load, into the storage unit for the matrix multiplication accumulation process, the first wave of the first data as the initial accumulator value, wherein the storage unit is an accumulator storage unit.
Aspect 13 is the apparatus of aspect 12, wherein to load, into the accumulator storage unit, the first wave of the first data as the initial accumulator value, the at least one processor is configured to: load, into the accumulator storage unit in a matrix multiplication unit (MMU) at a shader processor (SP) of a graphics processing unit (GPU), the first wave of the first data as the initial accumulator value.
Aspect 14 is the apparatus of any of aspects 1 to 13, wherein the at least one processor is further configured to: obtain the first wave of the first data associated with the graphics processing, wherein the allocation of the portion of the storage unit is based on the obtainment.
Aspect 15 is the apparatus of aspect 14, wherein to obtain the first wave of the first data, the at least one processor is configured to: receive, from a general purpose register (GPR) at a shader processor (SP) of a graphics processing unit (GPU), the first wave of the first data.
Aspect 16 is the apparatus of any of aspects 1 to 15, wherein the first data is associated with a matrix C for the matrix multiplication accumulation process, and wherein the second data is associated with a matrix A and a matrix B for the matrix multiplication accumulation process.
Aspect 17 is the apparatus of any of aspects 1 to 16, wherein to process the first data and the second data, the at least one processor is configured to: process, at a set of processing elements in a matrix multiplication unit (MMU) at a shader processor (SP) of a graphics processing unit (GPU), the first data and the second data.
Aspect 18 is the apparatus of any of aspects 1 to 17, wherein the first data is accumulator data for the matrix multiplication accumulation process.
Aspect 19 is the apparatus of any of aspects 1 to 18, wherein the at least one processor is further configured to: output an indication of a result of the processing of the first data and the second data.
Aspect 20 is the apparatus of aspect 19, wherein to output the indication of the result of the processing of the first data and the second data, the at least one processor is configured to: transmit the indication of the result of the processing of the first data and the second data; or store the indication of the result of the processing of the first data and the second data.
Aspect 21 is the apparatus of aspect 20, wherein the apparatus is a wireless communication device, further including (i.e., comprising) at least one of an antenna or a transceiver coupled to the at least one processor, wherein to transmit the indication of the result of the processing of the first data and the second data, the at least one processor is configured to: transmit, via at least one of the antenna or the transceiver, the indication of the result of the processing of the first data and the second data.
Aspect 22 is a method of graphics processing for implementing any of aspects 1 to 21.
Aspect 23 is an apparatus for graphics processing including means for implementing any of aspects 1 to 21.
Aspect 24 is a computer-readable medium (e.g., a non-transitory computer-readable medium) storing computer executable code (e.g., code for graphics processing), the code when executed by a processor causes the processor to implement any of aspects 1 to 21.

What is claimed is:

1. An apparatus for graphics processing, comprising:
at least one memory; and
at least one processor coupled to the at least one memory and, based at least in part on information stored in the at least one memory, the at least one processor is configured to:
allocate a portion of a storage unit for a first wave of first data, wherein the first data represents a block of output data;
store the first wave of the first data as an initial accumulator value for a matrix multiplication accumulation process; and
process the first data and second data included in the first wave, wherein the second data represents a block of input data.

2. The apparatus of claim 1, wherein the at least one processor is further configured to:
update the initial accumulator value of the first data to be an updated accumulator value of the first data based on a result of the processing of the first data and the second data.

3. The apparatus of claim 2, wherein to update the initial accumulator value of the first data based on the result of the processing of the first data and the second data, the at least one processor is configured to:
load, into the storage unit, the result of the processing of the first data and the second data.

4. The apparatus of claim 3, wherein to load, into the storage unit, the result of the processing of the first data and the second data, the at least one processor is configured to:
write, into the storage unit, the result of the processing of the first data and the second data.

5. The apparatus of claim 2, wherein the at least one processor is further configured to:
allocate a second portion of the storage unit for a second wave of third data;
store the second wave of the third data as a second initial accumulator value for the matrix multiplication accumulation process; and
process the third data and fourth data included in the second wave.

6. The apparatus of claim 5, wherein the at least one processor is further configured to:
update the second initial accumulator value of the third data based on a result of the processing of the third data and the fourth data.

7. The apparatus of claim 2, wherein the at least one processor is further configured to:
store the updated accumulator value of the first data to a general purpose register (GPR).

8. The apparatus of claim 7, wherein the at least one processor is further configured to:
deallocate the portion of the storage unit for the first wave of the first data based on the storage of the updated accumulator value of the first data.

9. The apparatus of claim 2, wherein the at least one processor is further configured to:
provide an indication of the updated accumulator value of the first data to at least one other component in a graphics processing unit (GPU).

10. The apparatus of claim 1, wherein to allocate the portion of the storage unit for the first wave of the first data, the at least one processor is configured to:
allocate the portion of an accumulator storage unit for the first wave of the first data, wherein the accumulator storage unit is for the matrix multiplication accumulation process.

11. The apparatus of claim 10, wherein the allocation of the portion of the accumulator storage unit is a persistent allocation of a shared storage for the matrix multiplication accumulation process.

12. The apparatus of claim 1, wherein to store the first wave of the first data as the initial accumulator value, the at least one processor is configured to:
load, into the storage unit for the matrix multiplication accumulation process, the first wave of the first data as the initial accumulator value, wherein the storage unit is an accumulator storage unit.

13. The apparatus of claim 12, wherein to load, into the accumulator storage unit, the first wave of the first data as the initial accumulator value, the at least one processor is configured to:
load, into the accumulator storage unit in a matrix multiplication unit (MMU) at a shader processor (SP) of a graphics processing unit (GPU), the first wave of the first data as the initial accumulator value.

14. The apparatus of claim 1, wherein the at least one processor is further configured to:
obtain the first wave of the first data associated with the graphics processing, wherein the allocation of the portion of the storage unit is based on the obtainment.

15. The apparatus of claim 14, wherein to obtain the first wave of the first data, the at least one processor is configured to:
receive, from a general purpose register (GPR) at a shader processor (SP) of a graphics processing unit (GPU), the first wave of the first data.

16. The apparatus of claim 1, wherein the first data is associated with a matrix C for the matrix multiplication accumulation process, and wherein the second data is associated with a matrix A and a matrix B for the matrix multiplication accumulation process.

17. The apparatus of claim 1, wherein to process the first data and the second data, the at least one processor is configured to:
process, at a set of processing elements in a matrix multiplication unit (MMU) at a shader processor (SP) of a graphics processing unit (GPU), the first data and the second data, wherein the first data is accumulator data for the matrix multiplication accumulation process.

18. The apparatus of claim 1, wherein the at least one processor is further configured to:
output an indication of a result of the processing of the first data and the second data.

19. A method of graphics processing, comprising:
allocating a portion of a storage unit for a first wave of first data, wherein the first data represents a block of output data;
storing the first wave of the first data as an initial accumulator value for a matrix multiplication accumulation process; and
processing the first data and second data included in the first wave, wherein the second data represents a block of input data.

20. A computer-readable medium storing computer executable code for graphics processing, the code when executed by at least one processor causes the at least one processor to:
allocate a portion of a storage unit for a first wave of first data, wherein the first data represents a block of output data;
store the first wave of the first data as an initial accumulator value for a matrix multiplication accumulation process; and
process the first data and second data included in the first wave, wherein the second data represents a block of input data.
